(19) United States
(12) Patent Application Publication
(10) Pub. No.: US 2007/0214040 A1
(43) Pub. Date: Sep. 13, 2007

(54) Method for prompting responses to advertisements

(75) Inventors: Labhesh Patel, San Francisco, CA (US); Sanjeev Kumar, San Francisco, CA (US); Mukul Jain, San Jose, CA (US); Shmuel Shaffer, Palo Alto, CA (US)

Correspondence Address: THE LAW OFFICES OF BRADLEY J. BEREZNAK, 800 WEST EL CAMINO REAL, SUITE 180, MOUNTAIN VIEW, CA, 94040, US

(73) Assignee: Cisco Technology, Inc., San Jose, CA (US)

(21) Appl. No.: 11/373,023

(22) Filed: Mar. 10, 2006

(51) Int. Cl. G06Q 30/00

(52) U.S. Cl. 705/14

(57) ABSTRACT

An automated method, performed by a computer-based system, for promoting responses to advertisements via a service provider (SP) network includes wirelessly transmitting a message to a mobile communication device when the mobile communication device is within a predetermined boundary range of an advertising location. The message includes a telephone number for responding to an advertisement. The subscriber is compensated based on a variety of criteria that includes responding to the advertisement by calling the telephone number. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

### RELATED APPLICATIONS

The present application is related to application serial no. ______ filed ______, entitled, “System and Method For Location-Based Mapping of Soft-Keys on a Mobile Communication Device”, filed concurrently herewith, and which application is assigned to the assignee of the present application.

### FIELD OF THE INVENTION

The present invention relates generally to the related fields of communication equipment and advertising systems; more specifically, to systems and methods of operation for presenting advertisement information to a mobile target.

### BACKGROUND OF THE INVENTION

Each year, companies spend vast sums of money on advertisements targeted to individuals who might be interested in the particular products and/or services offered by that business. The rapid technological advances that have occurred over the past decade in communications devices, media, and voice and data networks has lead to the development of ever more sophisticated systems and methods for delivering advertisements to a receptive audience.

By way of example, U.S. Pat. No. 6,545,596 teaches a system for presenting an advertisement on a mobile billboard apparatus such as a long-haul truck to mobile advertising targets (i.e., automobile drivers) based on location and profile information of the target drivers. Individual profile information is provided to the advertisers, who then direct the mobile advertising apparatus to position the billboard advertisement in the individual's viewing vicinity. A global positioning unit is used as the location device,

An example of a geographic-based communication system is found in U.S. Pat. No. 6,259,405, which teaches a plurality of access points connected to a network and arranged at known locations in a geographic region such that a mobile user may use a portable computing device to connect to and access information or services from the network. A system and method for using a location identity attribute of a recipient appliance to control access to digital information is also disclosed in U.S. Pat. No. 6,985,745. A system for locating a wireless mobile device in communication with a wireless local access network (WLAN) that includes a plurality of cells defining a WLAN, each having an access point base station, is taught in U.S. Pat. No. 6,987,744.

Many wireless telephone communication systems also provide a Short Message Services (SMS) feature that allows users to send and/or receive short text messages. For instance, many of the digital cell phones sold today are capable of sending and receiving SMS messages. Cellular telephone systems that provide SMS usually include a messaging server for receiving notification messages from a source (e.g., a voice mail, electronic mail, or paging system) in accordance with the Short Message Peer-to-Peer Protocol (SMPP). Some services are currently available that “push” (i.e., send or transmit) SMS messages onto a user's mobile phone (i.e., cellphone) based on some predefined criteria, such as known user profile information.

By way of further background, U.S. Patent Publication No. 2005/0272413 teaches a method that enables cellphone users to meet one another, on a permission basis, via SMS or other similar messaging/notification mechanisms. The determination of whether a given pair of mobile device users are introduced depends on whether the server determines they are in intellectual or “cognitive” proximity, which is typically a function of one or more factors, such as: each user's reciprocal networking objective, the nature of the industry in which the user works, the user's level within the management hierarchy of his or her company, any specialty function the individual may possess, and so on. Similar systems and methods have been proposed for pushing advertisements onto a user's cellphone or mobile communication device.

Occasionally, when an automobile driver passes by a roadside advertisement (“ad”) sign or billboard of interest they want to record a phone number or other information presented on the sign. For example, a person might drive past a billboard ad for a restaurant that includes a telephone number. The person may want to call the number to ask for directions or menu items, but memorizing the telephone number while driving a moving vehicle is not always easy. Often times, the person must pull over to the side of the road or turn around to drive past the sign—perhaps multiple times—in order to write down the relevant information. Not only is this a difficult, annoying procedure, but in certain situations it is impossible or dangerous due to traffic, lack of a suitable place to pull over in the vicinity of the advertisement, or other conditions.

Thus, what is needed is an advertising system and method of operation that overcomes the drawbacks inherent in the prior art, and which simply and automatically communicates essential advertisement information to users of mobile communication devices.

### BRIEF DESCRIPTION OF THE DRAWINGS

The present invention will be understood more fully from the detailed description that follows and from the accompanying drawings, which however, should not be taken to limit the invention to the specific embodiments shown, but are for explanation and understanding only.

FIG. 1 is a diagram that illustrates an advertising/communication system in accordance with one embodiment of the present invention.

FIG. 2 is a diagram that illustrates an advertising/communication system in accordance with another embodiment of the present invention.

FIG. 3 illustrates an advertisement database with coordinate location and radius information according to one embodiment of the present invention.

FIG. 4 shows an example of an advertisement display with softkey mapping on a cellphone in accordance with one embodiment of the present invention.

FIG. 5 shows an example listing of received advertisements displayed on a cellphone in accordance with one embodiment of the present invention.

FIG. 6 is a flow chart diagram of a method of operation according to one embodiment of the present invention.

### DETAILED DESCRIPTION

An advertising system that provides a mechanism for mapping an advertisement onto an input command button or soft-key of a person's mobile communication device, such as a cellphone, when that person is passing in close proximity to the ad, or is otherwise within a predefined market area, is described. In the following description specific details are set forth, such as device types, system configurations, protocols, methods, etc., in order to provide a thorough understanding of the present invention. However, persons having ordinary skill in the relevant arts will appreciate that these specific details may not be needed to practice the present invention.

According to one aspect of the present invention, advertisements are pushed onto a person's cellphone (or other similar mobile communication device) when that person passes through a certain geographic locality. In addition, an input command, such as a speed-dial keypad button or “soft-key” on the user's cellphone is automatically mapped (i.e., programmed) to allow the user to quickly recall relevant content of the advertisement and/or initiate a call to a telephone number listed in the ad. In other words, in one embodiment the present invention provides a content-sensitive, workflow-based, soft-key mapping onto a user's cellphone as that user passes through a certain locality.

In a specific implementation, the user's presence within the locality or market area is determined by a global positioning satellite navigational system (GPS). The user's location or current geographic position may also be determined by ordinary cellphone-based triangulation techniques. Alternatively, ads may be pushed onto a user's cellphone when the user passes within range of a wireless network access point (e.g., so-called “hotspots”), thereby obviating the need to calculate or determine the user's current geographic position.

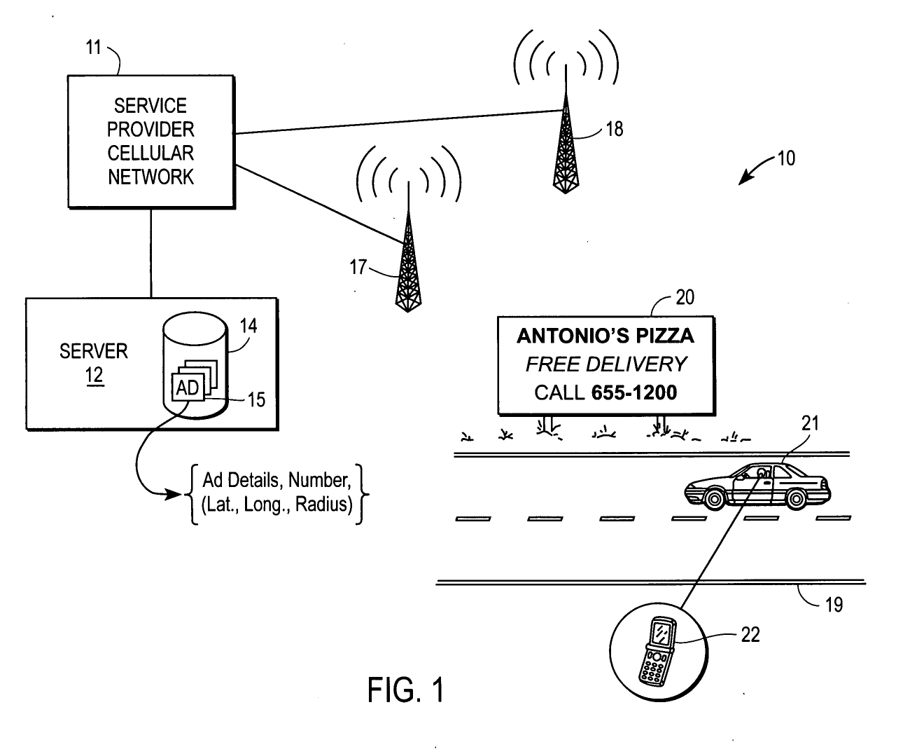

FIG. 1 illustrates an advertising system 10 according to one embodiment of the present invention. In this embodiment, the user contracts or otherwise consents with the service provider to receive advertisements, to receive soft-key mappings, and also to have the current geographic location of his cellphone tracked using known cellphone-based GPS or triangulation techniques. Triangulation is a known process by which the location of a radio transmitter (e.g., wireless phone 61) can be determined by measuring either the radial distance, or the direction, of the received signal from two or three different points (e.g., access points). Other existing tracking techniques, such as IP-based location methods, may also be used.

System 10 includes a service provider cellular network represented by block 11 comprising transmission base stations or antennas 17 & 18 and a server 12. User location monitoring, including GPS tracking or triangulation calculations, may be performed by one or more processors located anywhere on the network or within server 12. Server 12 includes hardware and software elements for managing the various components of cellular network 11 and antennas 17 & 18. Additionally, server 12 comprises a memory or database 14 that stores advertisements 15 along with associated ad information, which, in this embodiment includes advertisement content details, a telephone number, a latitude and longitude corresponding to the precise geographic location of the advertisement, and a geographic radius extending from the ad location. This radius defines the local market area or range of the advertisement.

Memory or database 14 may comprise any one or a combination of volatile or non-volatile, local or remote devices suitable for storing data, including magnetic or optical storage devices, random-access memory (RAM) devices, read-only memory (ROM) devices, or other types of data storage devices.

Also shown in FIG. 1 is a user of a cellphone 22, who is driving a vehicle (e.g., automobile) 21 along a road 19, and who is passing by a roadside sign/billboard (i.e., advertisement) 20. Advertisement 20 is for a pizza restaurant (“Antonio's Pizza”) offering free delivery, which ad also includes a telephone number of the business establishment. One of the functions of server 12 is to compare the current location of the user's cellphone against the location and radius of individual ads 15 stored in database 14. The comparison may be against all ads 15, or versus a selected subset of ads based on the particular terms and conditions agreed to between the user and the service provider.

Alternatively, or in additionally, the comparison may be based upon user preference settings or rules stored either in cellphone 22 or within a memory of server 12. The terms of the user's subscription contract, for instance, may be such that the user only consents to have food service ads pushed onto his cellphone. Another example is where a subscriber uses a keypad interface, textual user interface (TUI), which is a text-based version of a graphical user interface or a full-screen version of a command line interface, WEB, or other interface to set rules such that soft-keys are mapped only for ads from motels, spas, and restaurants. Advertisers may also provide information such as product category, prices, discounts, etc., that can be used to set preferences and rules. For example, a user can specify to map his soft-keys only for ads for hotels offering a king bed suite for less than $200. Thus, various types of ads may be filtered out based on different criteria either by at the service provider level (e.g., server 12) or at cellphone 22 via user-configured preference settings.

When the locality comparison results in a positive match, i.e., the user's current location is within the predefined location boundary or radius of an advertisement 20 of a type that the user has consented to receive, the ad details—including the telephone number—are automatically pushed onto cellphone 22 by cellular network service provider 11. Additionally, one or more new soft-key mappings corresponding to ad 20 are programmed or defined onto cellphone 22. In certain embodiments, cellphone 22 may emit an audible signal, tone, vibration, illuminated screen message, etc., alerting the user to the fact that a new ad has just been received.

It should be understood that cellphone 22 represents a specific example of a user communication apparatus or device suitable for receiving ads and mappings of soft-key buttons. In other words, cellphone 22 may be substituted or replaced by a variety of other devices, such as a portable computer, or any mobile wireless communication device, e.g., a pager, a personal digital assistant (PDA), or the like. A typical mobile communication device is a wireless access protocol (WAP)-enabled device that is capable of sending and receiving data in a wireless manner using the wireless application protocol. The wireless application protocol (“WAP”) allows users to access information via wireless devices, such as mobile phones, pagers, two-way radios, communicators, and the like. WAP supports a variety of wireless networks and it operates with many handheld device operating systems. Typically, WAP-enabled devices use graphical displays and can access the Internet (or other communication network) on so-called mini- or micro-browsers, which are web browsers with small file sizes that can accommodate the reduced memory constraints of handheld devices. Practitioners in the art will appreciate that the WAP protocol represents just one possible protocol that may be used in conjunction with the present invention. Other suitable protocols, such as the proposed G3 wireless protocol, may also be used.

In addition to a conventional voice communication, a given mobile device can communicate with another such device via many different types of message transfer techniques, including SMS, enhanced SMS, multi-media message (MMS), email WAP, paging, or other known or later-developed wireless data formats. In still other embodiments, the user's mobile communication device may be integrated with or implemented by components of vehicle 21, such as the vehicle's computer, radio, navigation, or other systems or equipment installed in vehicle 21.

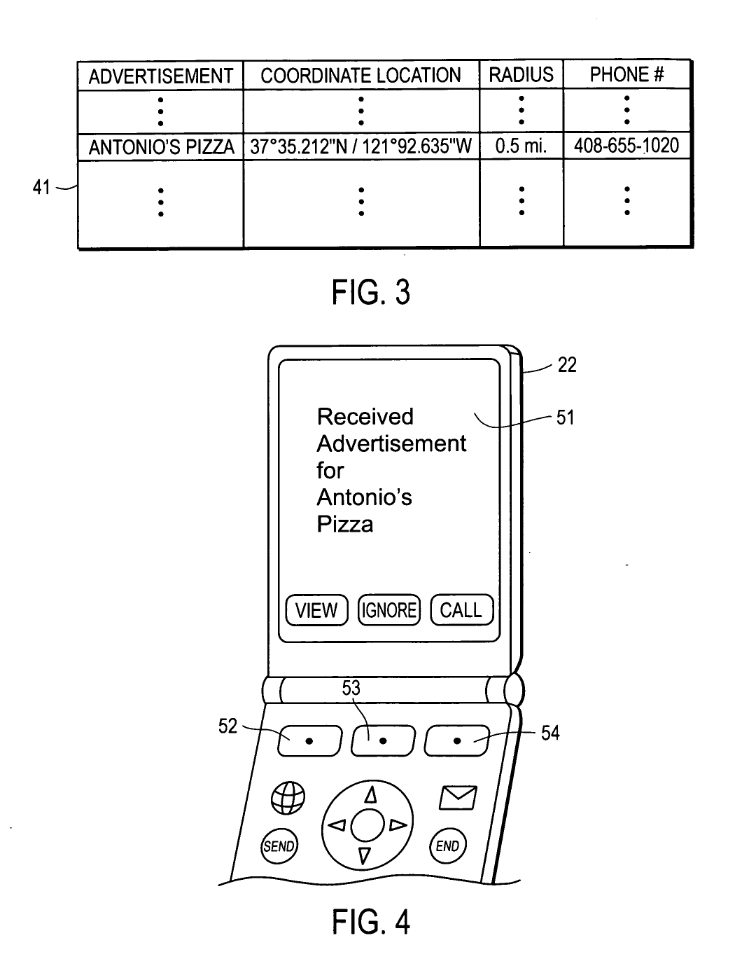

FIG. 3 illustrates an advertisement database according to one embodiment of the present invention. As can be seen, the advertisement database is arranged as a table 41 that includes separate data fields for each advertisement.

FIG. 3 shows, by way of example, four data fields that include entries for the name of the advertisement, the coordinate location of the ad, the radius or programmed range of the advertisement, and a phone number of the establishment. In this particular example the ad for Antonio's Pizza is shown having latitude/longitude of 37°35.212″N/121°92.635″W, a radius of one-half mile, and a phone number 408-655-1200 to contact the business or to otherwise respond to the ad.

FIG. 4 shows an example of an advertisement display with softkey mapping on a cellphone 22 in accordance with one embodiment of the present invention. In this embodiment, the service provider or advertising system administrator provides a software or firmware client module resident on cellphone 22 that automatically programs or updates one or more soft-keys in accordance with instructions received from server 12. Programming or installation of the client module for automatic soft-key mapping may occur at any time during the time that the user's subscription or service contract is valid, and may be effectuated in a variety of known methods.

Cellphone 22 includes a display screen 51 and soft-key buttons 52-54. In the example of FIG. 4, screen 51 shows a text message indicating that an advertisement for Antonio's Pizza has been received by cellphone 22. Displayed at the bottom of screen 51 are a set of command icons corresponding to commands or selections that have been automatically mapped onto soft-key buttons 52-54. For instance, the cellphone user may elect to view details of the advertisement (e.g., address, phone number, food menus, special offers, etc.) by pressing soft-key 52; ignore the message (which action may delete the message from cellphone 22 or simply clear screen 51); or automatically call the phone number associated with the ad by pressing soft-key 54. Thus, in this implementation, soft-key 54 functions as a speed-dial setting programmed or mapped onto cellphone.

Note that in a more basic embodiment, only the phone number and advertiser's name is mapped to the user's soft-keys. That is, additional information or details associated with an ad, such as physical address information, promotions, etc.—the so-called “envelope” information of the ad—need not be transmitted or displayed on the user's device.

It is also appreciated that other types of soft-key mappings and configurations are also possible. For instance, cellphone 22 may be configured such that a new ad is mapped to an existing soft-key sequence or speed-dial keypad sequence or strokes (e.g., #0-#9 may map to the ten most recently received ads).

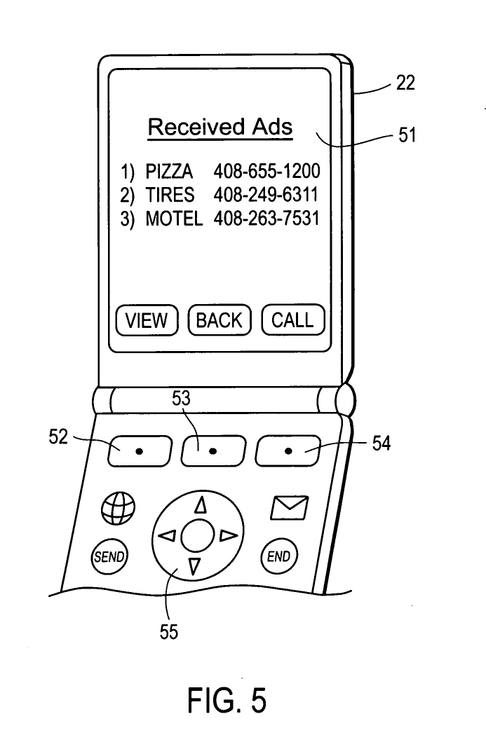

FIG. 5 illustrates a page or user interface window 51 of a user's cellphone 22 according to one embodiment in which a plurality of recently received ads is displayed in the form of a folder. Window 52 basically lists a recent history of advertisements that have been pushed onto cellphone 22, with the most recent ad being shown at the top of the list. In this example, a user may use a keypad input device 55 to scroll down the list of received ads. When a desired ad is highlighted, the user may then elect to view details of the advertisement, or directly call the phone number displayed, by pressing soft-key buttons 52 or 54, respectively. Alternatively, the user may press soft-key button 53 to go back to a previous window or menu page of display 51.

Note that the user may configure his cellphone with settings that determine the size or number of ads received. For instance, a user may set his cellphone to only store the last five ads received, with older ads being pushed out of the stored history as new ads are received. Alternatively, the service provider system may maintain a history of soft-key mappings associated with ads received based on user settings. In still other alternative implementations, the user' cellphone may be placed into a “locked” setting or configuration, in which soft-key mappings are not continuously updated as the user changes geographic location.

For example, at any time a user may browse his received ads and decide to lock his cellphone such that no new ads are received that might result in loss of his current ad history. In a more specific implementation, whenever a user locks his cellphone so as to not receive new ads and soft-key mappings, the system stores in a buffer a list of all new ads that the user would have received (based on his location and boundary range information) had his cellphone not been locked. When the user subsequently unlocks his cellphone to permit new soft-key mappings, the firmware client module on his cellphone may update the soft-key mappings with the ad information/listings contained in the buffer. Such a buffer may be maintained in server 12, e.g., within database 14, or in an external memory or storage location.

It should be understood that the mapping of soft-key buttons 52-54 occurs automatically via a firmware or software client resident on cellphone 22, wherein the softkeys are updated or programmed according to instructions received from the server side of the system. This updating or programming may take place prior to receiving an ad, on a periodic basis, or concurrent with the transmission of a new advertisement onto cellphone 22.

Consistent with the architecture of FIG. 1, a cellphone user may consent with cellular network service provider 11 to have the location of his cellphone tracked when the cellphone is activated (i.e., turned on) and to receive ads with soft-key mappings as a condition of his subscription or service contract. In one embodiment, the user or subscriber may receive account billing credits, commissions, or monthly service discounts based on criteria such as the number of ads received, ad responses (i.e., ad numbers called), purchases made based on ads received, etc. These calls and/or purchases can be tracked using conventional computer-automated accounting programs. According to this model, advertisers (e.g., shops, restaurants, motels, billboard advertisers, etc.) provide contact information (e.g., phone number) and their coordinate (i.e., global position) location to the service provider system. The system then continuously computes a location boundary or radius (e.g., 100 feet) around the user's current location and sends or pushes information associated with the ads that are within the location boundary, and which are of a type that the user has agreed to receive, onto the firmware client module of the user's cellphone. As the user moves around with his cellphone, the location boundary that extends around him also moves, such that as new advertisements are encompassed within the user's boundary range, the new ads are pushed onto the user's cellphone.

In one embodiment, the service provider chooses the boundary range or radius associated with a particular user. This radius can be also be a negotiable term of the user's service contract, wherein, for example, a user's monthly service charges may be reduced in cases where the user agrees to a wider radius. In another embodiment, advertisers may specify how near a person should be before their phone number (and other advertisement details) gets mapped to one or more of the user's soft-keys. In another embodiment, the user selects his radius, i.e., how near in physical proximity he should be to an ad site before a soft-key of his cellphone or other communication device gets mapped to the phone number of that advertiser.

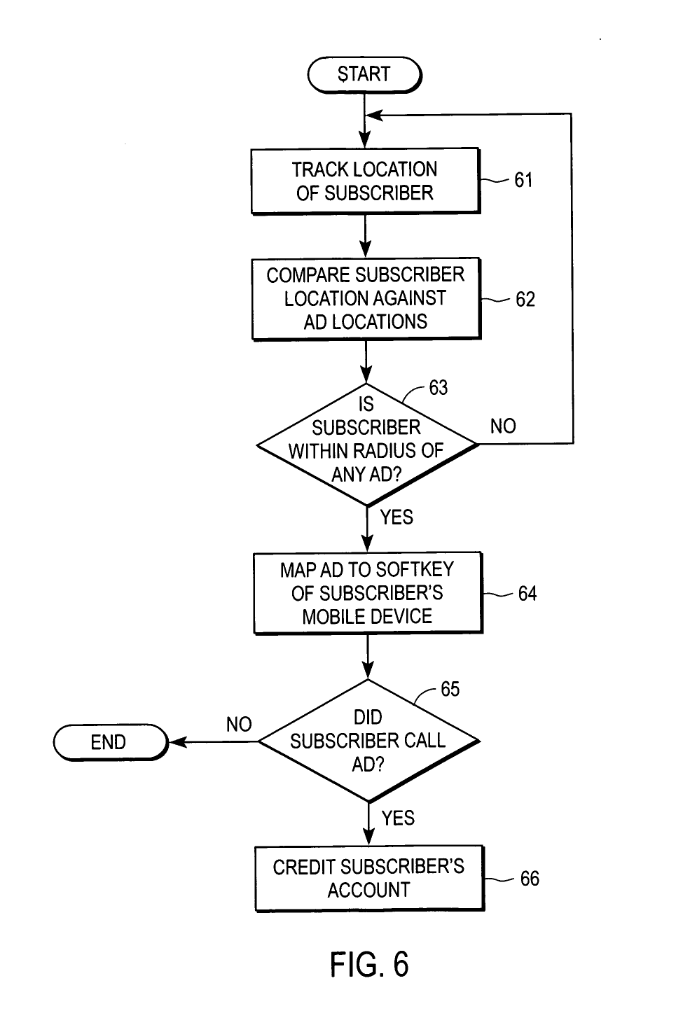

FIG. 6 is a flowchart diagram that illustrates a method of operation according to one embodiment of the present invention. The example of FIG. 6 begins with the tracking of the location of the subscriber (block 61). As discussed previously, tracking may be accomplished by GPS, triangulation, Internet-based, and other techniques. The system then compares the location of the subscriber against a database of registered ad locations (block 62). Whenever a subscriber is within a predetermined boundary range or radius of an ad (block 63) the ad is mapped to one or more soft-keys of the subscriber's cellphone or other mobile communication device (block 64). The embodiment shown in FIG. 6 also includes steps specific to a particular business model, which includes crediting a subscriber's account (block 66) in the event that the subscriber responded to the sent ad by calling the phone number mapped to his cellphone (block 65). In an alternate embodiment the end user may be credited based on his willingness to receive ads, wherein the service provider charges the advertiser for each occurrence of rendering the advertisement to the end-user's mobile phone.

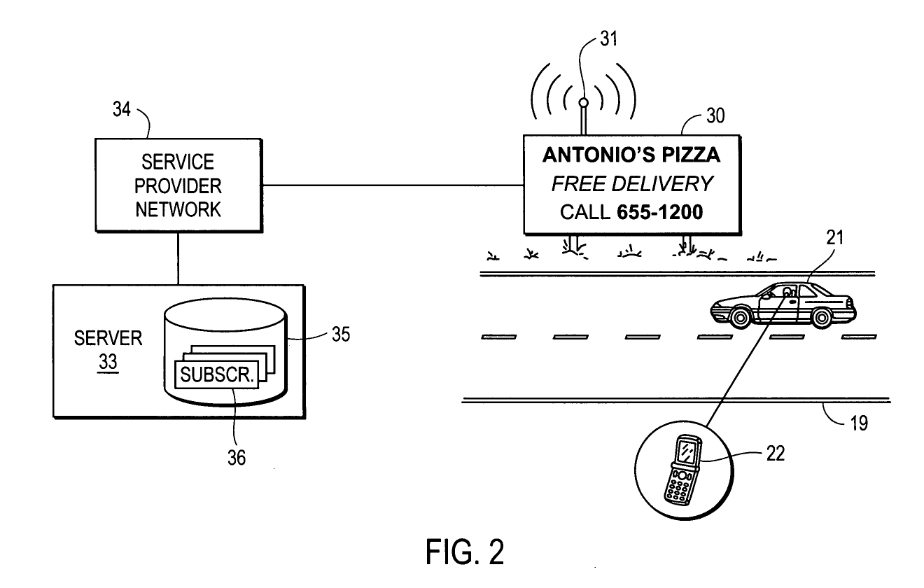

FIG. 2 is a diagram that illustrates an advertising/communication system in accordance with another embodiment of the present invention. The embodiment of FIG. 2 is similar to that shown in FIG. 1, except that in FIG. 2 the advertising site (i.e., shop, billboard, etc.) functions as a “hotspot” for wireless transmissions. A “hotspot” is generally defined as a specific geographic location in which an access point provides public wireless broadband network services to mobile users or visitors through a wireless local access network (WLAN). Hotspots usually have a short range of access. The hotspot function is represented in FIG. 2 by wireless device (with antenna) 31 mounted on ad billboard sign 30.

The main distinction therefore between the embodiments of FIGS. 1 and 2 is that in the previous embodiment, the billboard sign or advertising site is essentially passive, whereas in the embodiment of FIG. 2 the sign or advertising site is active in wirelessly transmitting ad information to the user recipient. Thus, in the embodiment of FIG. 2 each advertising site includes a wireless device that broadcasts a phone number of the advertiser along with (optionally) envelope information of the ad. Well-known wireless communication technologies/protocols such as Bluetooth™, WiFi, WiMax, IEEE 802.11a, b, or g, etc., may be utilized. The user's cellphone 22 (or other mobile wireless communication device) receives the phone number associated with the advertisement and a corresponding soft-key mapping when the user is within a certain predefined boundary range or radius of the ad hotspot. Alternatively, the boundary range may simply default to the hotspot's range of access.

In the embodiment of FIG. 2 the advertised phone number and advertiser's name are mapped to an available soft-key in a manner similar to that described previously in connection with the telephony-based solution. In a specific embodiment, envelope information is included in the broadcast advertisement, which information includes user credentials, such that the user's cellphone 22 accepts the advertised phone number and soft-key mapping only if it has been authorized by a service provider from whom the user has consented to receive advertisements.

Note that in the embodiment shown, instead of a cellular network service provider, a wireless service provider (e.g., Bluetooth™ service provider) 34 is shown connected with the wireless transmission device 31. Service provider 34 includes, or is coupled with, a server 33 having a database 35 that includes a listing or table 36 of current subscribers. Wireless service provider may transmit or download subscriber information (along with other information associated with the ad content) to wireless transmission device 31 on a one-time, periodic, or continual (real-time) basis.

In a variation of the embodiment of FIG. 2 the advertisement is placed on the vehicle itself such that vehicle 21 acts as a mobile hotspot. For instance, consistent with the example shown, instead of a stationary billboard, the owner of Antonio's pizza may hire or commission vehicle 21 to drive around town or within a vicinity of his business establishment in order to send ads to persons/subscribers eligible or who have agreed to receive such an ad. Consistent with the telephony embodiment, instead of a mobile hotspot, the location of vehicle 21 may be monitored by the network service provider such that when a location proximity match between vehicle 21 and a user/subscriber of cellphone 22 occurs, an ad is pushed on to cellphone 22 along with a soft-key mapping. In this embodiment, the driver of the vehicle may be compensated with a commission based on the number of people within his vicinity radius who respond to a transmitted ad.

It should be further understood that elements of the present invention may be provided as a computer program product which may include a machine-readable medium having stored thereon instructions which may be used to program a computer (e.g., a processor or other electronic device) to perform a sequence of operations. Alternatively, the operations may be performed by a combination of hardware and software. The machine-readable medium may include, but is not limited to, floppy diskettes, optical disks, CD-ROMs, and magneto-optical disks, ROMs, RAMs, EPROMs, EEPROMs, magnet or optical cards, propagation media or other type of media/machine-readable medium suitable for storing electronic instructions. For example, elements of the present invention may be downloaded as a computer program product, wherein the program may be transferred from a remote computer, server, or telephonic device to a user's communication device via signals embodied in a carrier wave or other propagation medium via a communication link (e.g., a modem or network connection).

Additionally, although the present invention has been described in conjunction with specific embodiments, numerous modifications and alterations are well within the scope of the present invention. Accordingly, the specification and drawings are to be regarded in an illustrative rather than a restrictive sense.

We claim:

1. An automated method, performed by a computer-based system, for promoting responses to advertisements via a service provider (SP) network comprising:
wirelessly transmitting a message to a mobile communication device when the mobile communication device is within a predetermined boundary range of an advertising location, the message including a telephone number for responding to an advertisement; and
compensating the subscriber for calling the telephone number.

2. The automated method of claim 1 further comprising:
mapping the telephone number to a soft-key button of the mobile communication device.

3. The automated method of claim 1 wherein the mobile communication device comprises a cellphone and the SP network comprises a cellular SP network.

4. The automated method of claim 1 wherein compensating the subscriber comprises:
providing a credit to an account of the subscriber.

5. The automated method of claim 1 wherein compensating the subscriber comprises:
providing a commission to the subscriber.

6. An automated method, performed by a computer-based system, for promoting responses to advertisements via a service provider (SP) network comprising:
determining that a mobile communication device of a subscriber to the SP network is within a predetermined boundary range of an advertising location;
wirelessly transmitting a message to a mobile communication device, the message mapping a telephone number for responding to an advertisement to a soft-key button of the mobile communication device; and
remunerating the subscriber each time the subscriber calls the telephone number to purchase products or services associated with the advertisement.

7. The automated method of claim 6 wherein the mobile communication device comprises a cellphone and the SP network comprises a cellular SP network.

8. The automated method of claim 6 wherein remunerating the subscriber comprises:
providing a credit to an account of the subscriber.

9. The automated method of claim 6 wherein remunerating the subscriber comprises:
providing a commission to the subscriber.

10. A method for promoting responses to ads transmitted via access points of a service provider (SP) network to a cellphone of a subscriber to the SP network, the method comprising:
agreeing by the subscriber to have a current location of the cellphone tracked when the cellphone is activated, and to have a telephone number associated with an ad mapped to a soft-key of the cellphone each time the cellphone is within a predetermined boundary range of an access point;
remunerating the subscriber based on a criteria which includes a number of advertisements mapped to the cellphone.

11. The method of claim 10 wherein the criteria further includes a number of calls the subscriber places to telephone numbers mapped to the cellphone.

12. The method of claim 10 wherein the criteria further includes a number of purchases made by the subscriber for products or services associated with the advertisement.

13. The method of claim 10 further comprising:
filtering the ad based on a preference setting, such that the telephone number is only mapped to the soft-key of the cellphone when the ad satisfies the preference setting.

14. The method of claim 13 wherein the preference setting comprises a subscriber-selected preference setting.

15. A method for promoting responses to an advertisement comprising:
hiring a driver of a vehicle installed with the mobile access point to drive in a local vicinity of a business establishment;
wirelessly transmitting a message to cellphones of subscribers to a service provider (SP) network when the cellphones are within a predetermined boundary range of the vehicle, the message including a telephone number for responding to an advertisement; and
compensating the driver based on a criteria which includes a number of telephone calls placed to the business establishment responsive to the message transmissions.

16. The method of claim 15 wherein the criteria further includes a number of purchases made by the subscriber for products or services associated with the advertisement.

17. The method of claim 15 further comprising:
filtering the ad based on a preference setting, such that the telephone number is only mapped to the soft-key of the cellphone when the ad satisfies the preference setting.

18. The method of claim 15 wherein the compensating the driver comprises:
providing the driver with a commission.
